(19) United States
(12) Patent Application Publication
(10) Pub. No.: US 2012/0285106 A1
(43) Pub. Date: Nov. 15, 2012

(54) Bird Deterrent for Reflective Surface

(75) Inventor: Bruce Donoho, Mission Viejo, CA (US)

(73) Assignee: BIRD-B-GONE, INC., Mission Viejo, CA (US)

(21) Appl. No.: 13/467,717

(22) Filed: May 9, 2012

Related U.S. Application Data
(60) Provisional application No. 61/484,156, filed on May 9, 2011.

(51) Int. Cl. E04B 1/72; E06B 3/30

(52) U.S. Cl. 52/203

(57) ABSTRACT

Bird deterrents are described for preventing birds from flying into a glass or at least partially reflective surface. Preferred deterrents include first and second support beams coupled to first and second portions of a mesh that is disposed between the first and second support beams. The support beams can be removably coupled to the glass surface using first and second sets of suction cups that are slidably coupled to the first and second support beams, respectively.

This application claims the benefit of priority to U.S. provisional application having Ser. No. 61/484,156 filed on May 9, 2011. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is bird deterrents, and specifically, bird deterrents as they relate to glass or other clear or semi-clear materials.

### BACKGROUND

Various bird deterrents for preventing bird from flying into windows are known in the art. See, e.g., U.S. patent publ. no. 2003/0173042 to Haas (publ. September 2003); U.S. patent publ. no. 2004/0231612 to Thompson, III et al. (publ. November 2004); and US 2010/0223861 to Warwick (publ. September 2010). However, these known deterrents suffer from at least one or more of the following disadvantages: (1) lack means for securing the device's bottom; (2) obstructs a view through the glass surface; and (3) have limited attachment areas.

Thus, there is still a need for an improved bird deterrent device that lacks the various disadvantages of the known deterrents.

### SUMMARY OF THE INVENTION

The inventive subject matter provides apparatus, systems and methods of a bird deterrent device configured to prevent birds from flying into an at least partially reflective surface, and especially windows of a residence, or a commercial or industrial building. Without such a deterrent, it is common in certain geographical areas for countless numbers of birds to accidentally fly into windows or other glass surfaces, which can kill or severely injure the birds.

The bird deterrent device can include a first beam coupled to a first portion of a mesh, first and second support beams, which are coupled to first and second portions of a mesh, respectively, and so forth. Suction cups or sets of suction cups can be used to couple any portion of the device to the glass surface. In some preferred embodiments, a first set of suction cups could be used to couple a first support beam to a glass surface and a second set of suction cups could be used to couple a second support beam to a glass surface.

In preferred embodiments, some or all of the suction cups are slidably coupled to the support beams or mesh of the device. The slidably coupled suction cups advantageously enables the bird deterrent device to be coupled to various areas of the glass surface, as needed.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 illustrates a front view of an embodiment of a bird deterrent device.

FIG. 2 illustrates a back view of another embodiment of a bird deterrent device.

FIG. 3 illustrates an exploded view of yet another embodiment of a bird deterrent device.

FIG. 4A illustrates a frontal view of an embodiment of a bird deterrent device having a mesh, two support beams, and a locking strap.

FIG. 4B illustrates a back view of an embodiment of a bird deterrent device having a mesh, two support beams, and a locking strap.

FIG. 4C illustrates a view of an embodiment of a bird deterrent device having a mesh, two support beams, and a locking strap after it has been rolled up.

FIG. 5A illustrates a view of an embodiment of a bird deterrent device having a mesh and no support beams comprising four perforations.

FIG. 5B illustrates a view of an embodiment of a bird deterrent device having a mesh and no support beams comprising four perforations that have received four suction cups.

### DETAILED DESCRIPTION

One should appreciate that the disclosed techniques provide many advantageous technical effects including devices for preventing birds from flying into glass surfaces.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

Although the following discussion refers to a glass surface, it is contempaled that the bird deterrent device could be used with any at least partially reflective surface to thereby prevent birds from flying into the surface.

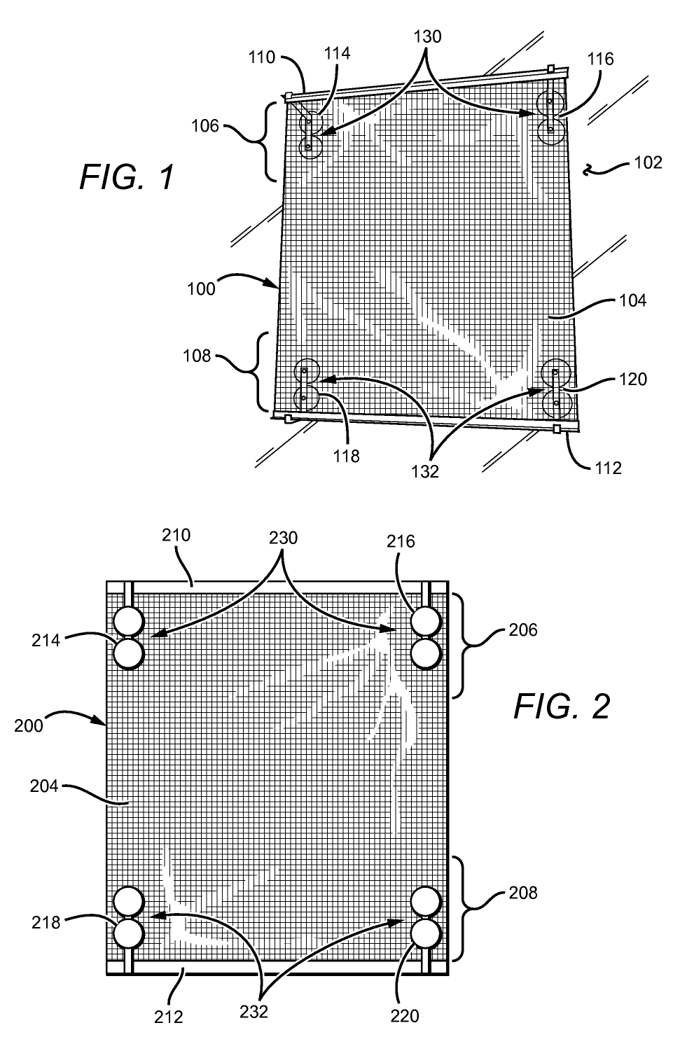

In FIG. 1, a bird deterrent device 100 is shown that advantageously prevents birds from flying into a glass surface 102. The device 100 can include a mesh 104 having a first portion 106 and a second portion 108. Preferred meshes are advantageously transparent to reduce the obstruction of light through the window, but translucent, opaque, colored, or even multi-colored meshes could also be used although less preferred. For example, a user might prefer a darker meshing so that the bird deterrent could also act as a tint or screen to limit the amount of sunlight passing through the glass surface 102, or a patterned meshing to make the bird deterrent esthetically pleasing.

The meshing could be formed of any commercially suitable material including, for example, metal, plastic, cotton, nylon, polyester, and hemp. It is contemplated that the meshing could comprise a weave including, for example, a honeycomb weave, a cross-weave, or a diamond weave. It is further contemplated that some mesh bird deterrents could include one or more areas without meshing. For example, some embodiments could include alternating horizontal strips of meshing and one or more other materials to reduce manufacturing costs or to incorporate a desirable design.

The device 100 can also preferably include first and second support beams 110 and 112, which are coupled to the first and second portions 106 and 108 of the mesh 104, respectively. The beams are preferably formed from an extruded plastic, although any commercially suitable material(s) could be used including, for example, other polycarbonates, metals and metal composites, and any combination(s) thereof. It is contemplated that each of the first and second support beams 110 and 112 could telescope, such that the beams can be extended or retracted as necessary to fit the window. It is also contemplated that one or both of the support beams 110 and 112 could be extendable such as by coupling an additional support beam to the first or second support beam 110, 112, for example.

While preferred embodiments include at least first and second support beams, it is also contemplated that some embodiments could have no support beam, or have only a single support beam. Embodiments without a support beam could include one or more perforations configured to accept a suction cup, or simply be lined with one or more adhesive strips configured to couple the device to the surface. Contemplated adhesive strips include no-residue duct tape, stock tape, custom-engineered tape, and so forth. Single support beams could be useful in embodiments that include at least one area of curvature.

It is further contemplated that a support beam could comprise a flexible material to allow for flexibility of the support beam around corners and curves of structures, for example. It is also contemplated that the support beam could be of any commercially suitable size and thickness. Some contemplated embodiments could include a plurality of short support beams coupled to various portions of the device 100 to allow for an overall increased flexibility of the device 100.

The first and second support beams 110 and 112 are preferably coupled to the glass surface 102 via first and second sets 130 and 132 of suction cups, respectively. This is especially advantageous, as the second set of suction cups can be used to adhere the second support beam 112, and thereby the second portion of the mesh, to the glass surface 102, which thereby prevents the second beam 112 from hitting, and possibly breaking or otherwise damaging, the glass surface 102. In preferred embodiments, the first set 130 of suction cups comprises first and second pairs 114 and 116 of suction cups, and the second set 132 of suction cups comprises third and fourth pairs 118 and 120 of suction cups.

In some contemplated embodiments, each of the first and second, and third and fourth, pairs of suction cups 114, 116, 118, 120 can be slidably coupled to the first and second support beams 110 and 112, respectively. This is beneficial over prior art devices because the slidably mounted suction cups can be translated, as necessary, to allow for proper mounting of the device 100 to the glass surface 102. However, the suction cups could alternatively be coupled to the support beams by any other suitable means, such as molding through the mesh material, glue, sewing, clipping, or any other commercially suitable fastener(s). In addition, the first set of suction cups is preferably coupled to the first support beam 110, such that the suction cups are below the support beam when the mesh 104 is vertically mounted to the glass surface 102, such as shown in FIG. 1. In a similar fashion, the second set of suction cups is preferably coupled to the second support beam 112, such that the suction cups are above the support beam, when the mesh 104 is vertically mounted to the glass surface 102. This advantageously allows the device 100 to extend to the upper and lower edges of the glass surface 102, despite using suction cups to mount the device 100 to the glass surface 102.

In other contemplated embodiments, either of the first or second support beams 110 or 112, respectively, could include a spring-loaded carrier (shown in FIG. 2) configured such that the mesh 104 can be automatically retracted into the carrier when no longer in use. Alternatively, the spring-loaded carrier could be coupled to either of the first or second support beams 110 or 112. By automatically retracting the mesh into the carrier, the mesh can advantageously be safely stored and reused when needed with damaging the mesh. It is contemplated that the spring-loaded carrier could be controlled by a remote control device, or a timer, such that someone could extend or retract the mesh without requiring opening of the window or accessing the device from outside. Thus, the mesh could thereby be remotely or automatically positioned even 10, 20, 50, 100, or thousands of feet away from the device.

It is preferred that each of the first and second support beams 110 and 112 is configured to receive corresponding first and second support beams from a similarly-constructed bird deterrent device. In this manner, multiple devices can be coupled together easily to effectively cover a glass surface. In embodiments of the device lacking support beams, a portion of one bird deterrent device could comprise a zipper, hook or loop fastener, buttons, clips, or other commercially suitable fastener(s) or combinations thereof that are configured to couple with a corresponding fastener of an adjacent bird deterrent device.

In other contemplated embodiments, the device 100 could be configured to completely align with a surface of a window so that air does not flow in between the window and the device. For example, the device 100 could comprise a mesh material and adhesive material along the edges so the device could be configured to lie flat against a window, or the device could comprise four support beams that are long rectangular tubes, and the suction cups could be configured to couple with a rectangular mesh so that the ends of the suction cups (when attached) and the rectangular beams align to form at least a partial seal against a window.

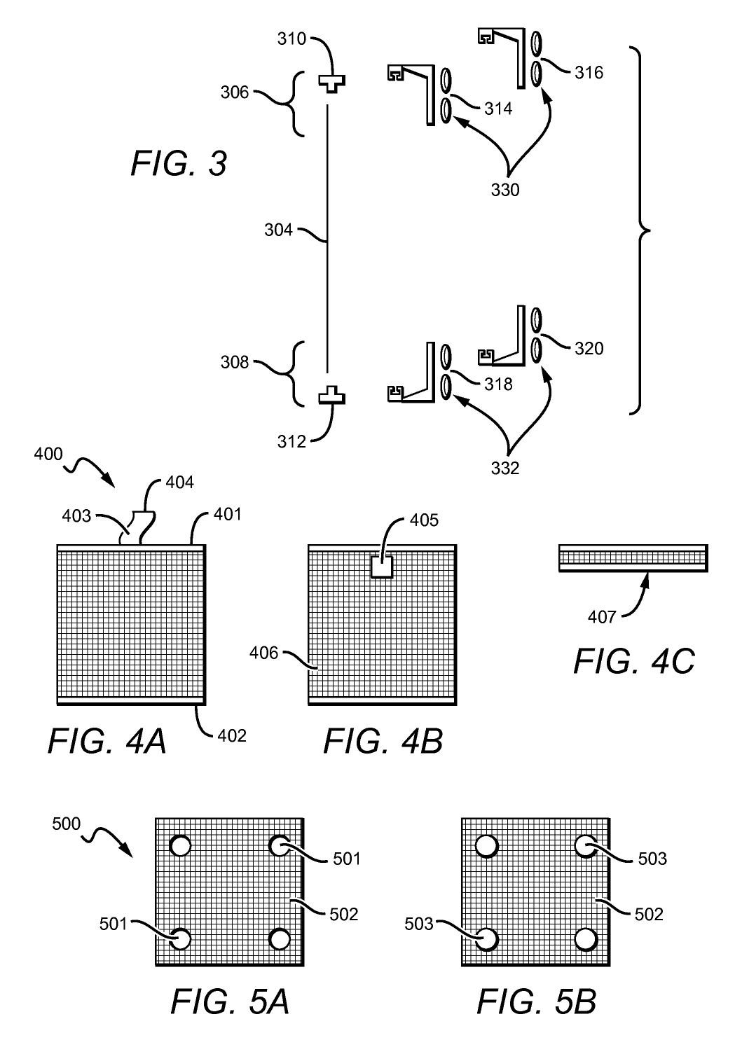

FIG. 2 illustrates a back view of an embodiment of a bird deterrent device 200. FIG. 3 illustrates an exploded view of another embodiment of a bird deterrent device 300. With respect to the remaining numerals in each of FIGS. 2 and 3, the same considerations for like components with like numerals of FIG. 1 apply.

One or more locking straps could be included in some embodiments of the inventive subject matter. FIGS. 4A-4C shows an embodiment of a bird deterrent device 400 having two support beams 401 and 402, a locking strap 403 coupled to one of the support beams at one end with a hook or loop fastener at a portion of the free end 404, and a hook or loop fastener 405 located on at least a portion of the mesh 406. When the device is rolled up 407, the locking strap could be configured to wrap around the device and couple with the hook or loop fastener on the meshing material of the device. Any commercially suitable fastener or fasteners could be used to couple the locking strap with the mesh or support beam, including for example, a hook and loop fastener, a button and perforation, and a zipper.

FIGS. 5A-5B illustrates an embodiment of a bird deterrent device 500 having no support beams to allow for increased flexibility. There are four perforations 501 on the mesh material 502 configured to accept at least four suction cups 503, although any commercially suitable fastener(s) could be used.

Apparatus, systems and methods for painting-on or spraying-on anti-reflective coatings, such as ultraviolet (UV) coatings, are also contemplated. Contemplated anti-reflective coatings include index-matching, single-layer interference, multi-layer interference, absorbing, and moth eye. Preferred embodiments could include a square spray nozzle to allow a user to easily spray more rectangular patterns onto windows or other materials. Other embodiments could include spray nozzles that allow two rectangles to be sprayed at the same time with a vertical gap so that a user could spray two or more windows at the same time. However, all types of spray nozzles are contemplated. Such coatings could be used on various surfaces, including for example, a window, a wind turbine blade, or any other at least partially reflective surface.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A bird deterrent for preventing birds from flying into a glass surface, comprising:
a mesh having a first portion and a second portion;
first and second support beams coupled to the first and second portions, respectively;
first and second sets of suction cups coupled to the first and second support beams, respectively; and
wherein the first and second sets of suction cups are (a) slidably coupled to the first and second support beams, respectively, and (b) configured to removably attach to a glass surface.

2. The bird deterrent of claim 1, wherein the glass surface comprises a window pane.

3. The bird deterrent of claim 1, wherein each of the first and second sets of suction cups comprises first and second pairs of suction cups.

4. The bird deterrent of claim 1, wherein the first set of suction cups is configured to be coupled to an upper portion of the glass surface, and the second set of suction cups is configured to be coupled to a lower portion of the glass surface.

5. The bird deterrent of claim 1, further comprising a spring-loaded carrier that is disposed to interconnect the first set of suction cups to the mesh, and wherein the spring-loaded carrier is configured to auto-retract the mesh into the carrier.

6. The bird deterrent of claim 1, wherein the first support beam comprises a spring-loaded carrier configured to auto-retract the mesh into the carrier.

7. The bird deterrent of claim 1, wherein the mesh is transparent.

8. A system for preventing birds from flying into a glass surface, comprising:
first and second bird deterrents of claim 1; and
wherein the first and second support beams of the first bird deterrent are configured to receive the first and second support beams of the second bird deterrent, respectively.
